(19) United States
(12) Patent Application Publication
(10) Pub. No.: US 2025/0047317 A1
(43) Pub. Date: Feb. 6, 2025

(54) SYSTEM FOR PET TRAINING

(71) Applicant: Analytical Horsepower LLC, Melbourne, FL (US)

(72) Inventor: James E. Stern, Merritt Island, FL (US)

(21) Appl. No.: 18/363,139

(22) Filed: Aug. 1, 2023

(51) Int. Cl. H04B 1/40

(52) U.S. Cl. CPC H04B 1/40

(57) ABSTRACT

A system including a transmitter and a receiver. The transmitter has a human machine interface and a plurality of magnets. The receiver has a noise generator and a vibration motor. The receiver has a first state and a second state. The receiver includes a proximity sensor. The receiver is configured to change from the first state to the second state in response to detection of a magnetic field by the proximity sensor. The transmitter is pairable with the receiver when the receiver is in the second state. The noise generator and the vibration motor are each operable by the human machine interface when the transmitter and the receiver are paired. The transmitter is magnetically couplable to a user device by the plurality of magnets.

### BACKGROUND

Training of a dog or other pet can be done using various techniques and devices. These techniques and devices include positive and negative reinforcement. The dog responds to the positive and/or negative reinforcement and learns what behaviors are desirable or undesirable. Consistent use of the training techniques and devices is important to successful and timely training of the dog.

### BRIEF DESCRIPTION OF THE DRAWINGS

FIG. 1A is a top perspective view of a transmitter.

FIG. 1B is an exploded view of FIG. 1A.

FIG. 2A is a bottom perspective view of the transmitter.

FIG. 2B is an exploded view of FIG. 2A.

FIG. 3 is a top perspective view of a receiver.

FIG. 4 is a bottom perspective view of the receiver.

FIG. 5 is a perspective view of the receiver with a clip.

FIG. 6 is a perspective view of a base of the transmitter.

FIG. 7 is a view of the transmitter, a second transmitter, a user device, and a pet.

FIG. 8 is a block diagram of a method of operating the receiver.

FIG. 9 is a block diagram of a method of operating the receiver.

FIG. 10 is a block diagram of a method of operating the receiver.

FIG. 11 is a side view of the user device.

### DETAILED DESCRIPTION

With reference to the Figures, wherein like numerals indicate like parts throughout the several views, a system including a transmitter 10 and a receiver 12 is shown. The transmitter 10 has a human machine interface 14 and a plurality of magnets 16. The receiver 12 has a noise generator 18 and a vibration motor 20. The receiver 12 has a first state and a second state. The receiver 12 includes a proximity sensor 22. The receiver 12 is configured to change from the first state to the second state in response to detection of a magnetic field by the proximity sensor 22. The transmitter 10 is pairable with the receiver 12 when the receiver 12 is in the second state. The noise generator 18 and the vibration motor 20 are each operable by the human machine interface 14 when the transmitter 10 and the receiver 12 are paired. The transmitter 10 is magnetically couplable to a user device 24 by the plurality of magnets 16.

Training of a pet may include using the system of the transmitter 10 and the receiver 12 to alert the pet of positive or negative behavior. Because the transmitter 10 is magnetically couplable to the user device 24, for example, a mobile device, the transmitter 10 is easily accessible to the user and the user can use one hand to hold the user device 24 and the operate the components of the receiver 12 via the transmitter 10 at the same time. Additionally, since the transmitter 10 is magnetically couplable to the user device 24, the user does not need to keep track of separate devices when playing or training their pet, i.e., if the user has the user device 24 then the user will have the transmitter 10 because the transmitter 10 is magnetically coupled to the user device 24. Because the transmitter 10 is easily accessible to the user, i.e., magnetically coupled to the user device 24, the user can consistently use the system to train the pet and see results of their training efforts quickly. Since the receiver 12 includes a noise generator 18 and vibration motor 20, the receiver 12 alerts the dog that certain behaviors are undesirable without hurting the dog. Similarly, when the dog is confronted with a stimulus, e.g., a squirrel, a leaf, food scraps on the street, use of the noise generator 18 and/or vibration motor 20 can easily and painlessly get the attention of the dog away from the stimulus and back to the owner or trainer.

The system includes the transmitter 10. As shown in the Figures, the transmitter 10 has a central axis A1. The transmitter 10 may include a housing 26. As an example, shown in the Figures, the housing 26 may be cylindrical, i.e., the housing 26 has a height and the housing 26 may be generally circular, i.e., having a circumference, a diameter, a radius, etc. Generally circular means the housing 26 may not be a perfect circle, e.g., the diameter and the radius of the housing 26 may vary. As another example, the housing 26 may be any suitable shape, e.g., oval, square, rectangular, etc.

The transmitter 10 is designed to be magnetically coupled to a user device 24. Specifically, the housing 26 is designed to be magnetically coupled to the user device 24. As one example, the user device 24 may be a mobile device, e.g., a cell phone. As another example, the user device 24 may be any suitable user device 24 that includes a ferromagnetic material in a location that the user would like to magnetically couple the transmitter 10. In the example shown in the Figures, the housing 26 has a diameter (not numbered) such that it may be magnetically coupled to the user device 24 and fit completely within the dimensions of the user device 24, i.e., the diameter of the housing 26 is less than the width of the user device 24.

The transmitter 10, and specifically the housing 26, may have a top section 28 and a bottom section 30, as described below. The housing 26 may have a first diameter D1 and a second diameter D2. The first diameter D1 is less than the second diameter D2. As shown in the Figures, the top section 28 of the housing 26 has the first diameter D1 and the bottom section 30 of the diameter has the second diameter D2.

The transmitter 10 is designed to be held, e.g., within the user's fingers, comfortably by the user when the user is holding the user device 24 and the transmitter 10 is magnetically coupled to the user device 24. Specifically, the housing 26 is designed to be held, e.g., within the user's fingers, comfortably by the user when the user is holding the user device 24. In the example shown in the Figures, the first diameter D1 is preferably in the range of 2.21-2.22 inches and the second diameter D2 is preferably in the range of 1.96-1.97 inches.

The transmitter 10 is designed to allow the user to comfortably store the user device 24 on the user when the transmitter 10 is magnetically coupled to the user device 24. Specifically, the height of the transmitter 10 allows the user to comfortably store the user device 24 on the user when the transmitter 10 is magnetically coupled to the user device 24. As an example, the user may store the user device 24 with the transmitter 10 magnetically coupled to the user device 24 in a pocket of the user's clothing, e.g., the pocket of pants. In this example, the height of the transmitter 10 is designed to fit in the pocket of the user's clothing and to avoid any unsightly bulges in the clothing. The height of the transmitter 10, and specifically the housing 26, is preferably in the range of 0.44-0.46 inches. The housing 26 may be of any suitable size, i.e., height, diameter, etc.

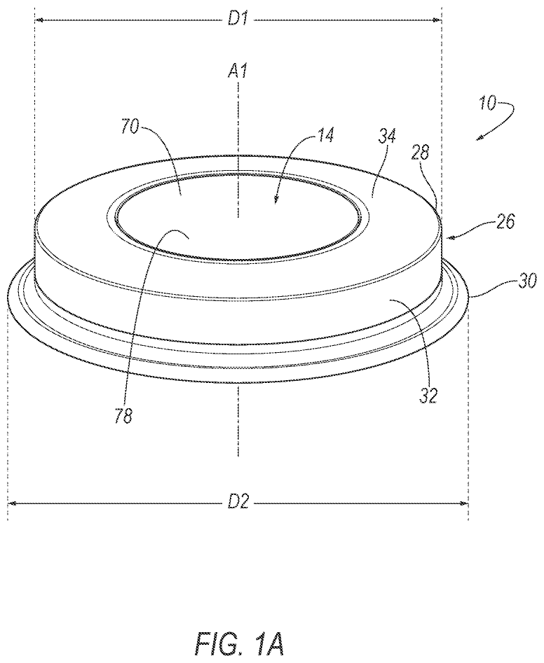

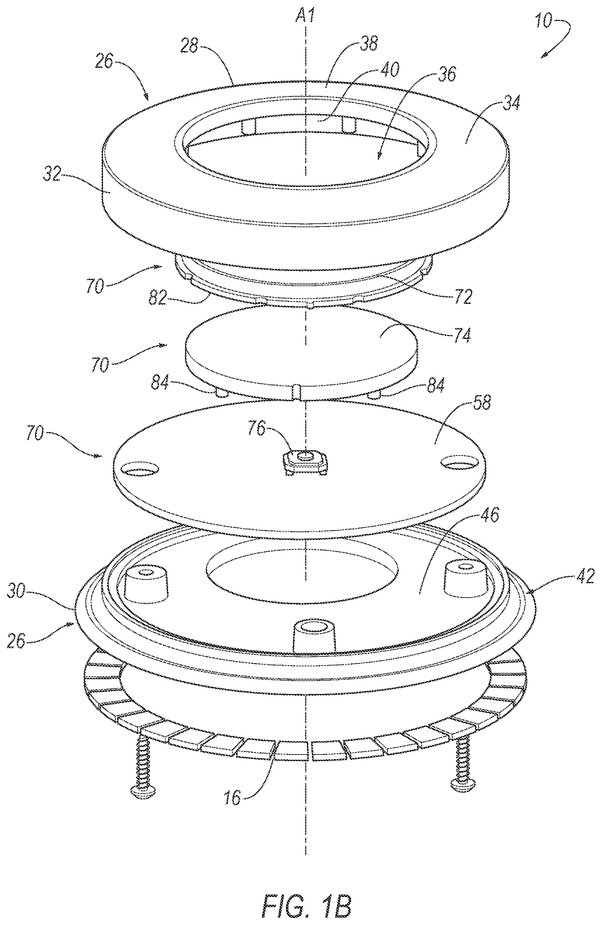

As shown in FIGS. 1A and 1B, the housing 26 has the top section 28 and the bottom section 30. In the example shown in the Figures, the top section 28 and the bottom section 30 are separate components, i.e., formed separately and subsequently assembled, e.g., by fasteners, welding, adhesive, etc. As another example, the housing 26 may be of a unibody construction in which the top section 28 is unitary with the bottom section 30. Unitary means a single, uniform piece of material with no seams, joints, fasteners, or adhesives holding it together, i.e., formed together simultaneously as a single continuous unit, e.g., by machining from a unitary blank, molding, etc.

The top section 28 has a side 32 and a top flange 34. The top flange 34 extends from the side 32 inwardly toward the central axis A1. The side 32 extends downward from the top flange 34. Specifically, the side 32 extends downward from the top flange 34 toward the bottom section 30. The side 32 and the top flange 34 extend continuously around the central axis A1. The top section 28 includes an opening 36 extending radially from the central axis A1. Specifically, the flange defines the opening 36 in the top section 28. As discussed below, the human machine interface 14 is disposed in the opening 36. The top section 28 has an outer wall 38 facing the environment and an inner wall 40 spaced inward from the outer wall 38. The top section 28 has a wall thickness (not shown), i.e., the distance between the outer wall 38 and the inner wall 40 is the wall thickness.

The bottom section 30 has an outer edge 42. The bottom section 30 extends radially from the central axis A1 to the outer edge 42, i.e., the bottom section 30 is generally circular. The bottom section 30 includes an outer wall 44 and an inner wall 46 spaced upward relative to the outer wall 44. The bottom section 30 has a wall thickness (not shown), i.e., the distance between the outer wall 44 and the inner wall 46 is the wall thickness. The outer wall 44 may define a bottom surface 48 of the bottom section 30.

The bottom section 30 may include a channel 50. As shown in the Figures, the channel 50 is adjacent the outer edge 42 of the bottom section 30 and extends inward toward the central axis A1. The channel 50 extends continuously around the outer edge 42 of the bottom section 30. The channel 50 includes a recess surface 52 and two sidewalls 54 spaced from and opposing each other. One of the two sidewalls 54 may define the outer edge 42. The channel 50 is recessed upwardly relative to the bottom surface 48 of the bottom section 30. Specifically, the two sidewalls 54 extend upwardly from the bottom surface 48, i.e., toward the top section 28, to the recess surface 52. The channel 50 is sized, i.e., the width and height, to receive the plurality of magnets 16.

The transmitter 10 includes the plurality of magnets 16. The plurality of magnets 16 may be supported on the housing 26. As shown in the Figures, the plurality of magnets 16 are supported on the bottom section 30 of the housing 26. Specifically, the plurality of magnets 16 may be arranged adjacent the outer edge 42 of the bottom section 30. The plurality of magnets 16 may be arranged within the channel 50 of the bottom section 30 of the housing 26. The plurality of magnets 16 may be flush with the bottom surface 48 of the bottom section 30, i.e., the height of the channel 50 is designed to receive the plurality of magnets 16 such that the plurality of magnets 16 are flush with the bottom surface 48 of the bottom section 30. In the example shown in the Figures, the plurality of magnets 16 and the bottom surface 48 of the bottom section 30 are coplanar. In other examples (not shown), where the housing 26 is not generally circular, the channel 50 may have any suitable path on the bottom section 30 of the housing 26. In these examples, the plurality of magnets 16 may be arranged in any suitable manner in the channel 50.

The plurality of magnets 16 may be supported on the bottom section 30 of the housing 26 by, e.g., glue, welding, overmolding, etc. The plurality of magnets 16 may be integral with the bottom section 30, e.g., the plurality of magnets 16 may be overmolded into the bottom section 30. In examples where the plurality of magnets 16 are overmolded into the bottom section 30, the bottom surface 48 may extend between the plurality of magnets 16 and the user device 24. In such an example, the portion of the bottom surface 48 between the plurality of magnets 16 and the user device 24 is designed to be thin such that the plurality of magnets 16 magnetically couples the transmitter 10 to the user device 24. In other examples (not shown), the transmitter 10 may include a single continuous magnet, i.e., in lieu of the plurality of magnets 16. In such examples, the single continuous magnet may extend partially or entirely around the bottom section 30.

The user device 24 may have a magnetic array 56 and the plurality of magnets 16 are arranged to align with the magnetic array 56 of the user device 24. The magnetic array 56 of the user device 24 may have any suitable size and shape. As an example, shown in the Figures, the magnetic array 56 of the user device 24 may be, e.g., ring-shaped. The magnetic array 56 may, for example, be the iPhone MagSafe magnetic array 56.

The transmitter 10 is magnetically couplable to the user device 24 by the plurality of magnets 16. Specifically, the transmitter 10 is magnetically couplable with the magnetic array 56 of the user device 24 by the plurality of magnets 16. The plurality of magnets 16 are arranged such that the polarity of the plurality of magnets 16 is opposite the polarity of the magnetic array 56 of the user device 24. In the example where the magnetic array 56 of the user device 24 is ring-shaped, the bottom section 30 of the housing 26 and the channel 50 are sized and shaped such that the plurality of magnets 16 align with the magnetic array 56. In other examples, the user device 24 may have a magnetic array 56 of any suitable size and shape and the plurality of magnets 16 of the transmitter 10 are arranged to align with the size and shape of that magnetic array 56.

The plurality of magnets 16 are designed to comfortably couple the transmitter 10 with the user device 24 and comfortably decouple the transmitter 10 from the user device 24. Specifically, the user may hold the user device 24 using the transmitter 10 when the transmitter 10 is magnetically coupled with the user device 24, as described above. When the user holds the user device 24 using the transmitter 10 the plurality of magnets 16 are designed such that the transmitter 10 does not move relative to the user device 24. Additionally, the plurality of magnets 16 are designed such that the transmitter 10 may be easily decoupled from the user device 24 when the user wants to decouple the transmitter 10, and the transmitter 10 is not easily decoupled from the user device 24 when the user does not want to decouple the transmitter 10. Specifically, the plurality of magnets 16 may be N52 Neodymium magnets. As discussed above, the plurality of magnets 16 and the bottom surface 48 of the bottom section 30 may be coplanar. Because the plurality of magnets 16 and the bottom surface 48 of the bottom section 30 are coplanar, there is no gap between the bottom surface 48 and the user device 24 which may affect the case of coupling and decoupling the transmitter 10 from the user device 24.

As discussed above, the transmitter 10 is designed to be held comfortably by the user. Specifically, the transmitter 10 is designed to be used comfortably by the user. In examples where the plurality of magnets 16 are N52 Neodymium magnets, the first diameter D1 of the transmitter 10 is between 1.96 and 1.97 inches, and the height of the transmitter 10 is between 0.44-0.46 inches, the transmitter 10 may be used comfortably by the user. Because the plurality of magnets 16 are N52 neodymium magnets, the transmitter 10 will remain magnetically coupled to the user device 24 when the transmitter 10 is held between the index finger and the ring finger of the user. Because the first diameter D1 is between 1.96 and 1.97 inches, the transmitter 10, and specifically the button assembly 70 as described below, can be operated by the user's middle finger while the transmitter 10 is held between the index finger and the ring finger of the user. In other words, the user can operate the transmitter 10 while operating the user device 24, e.g., a cell phone, with the user's thumb.

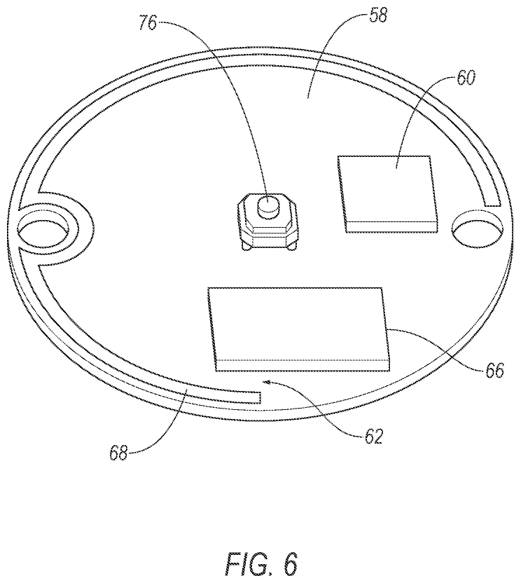

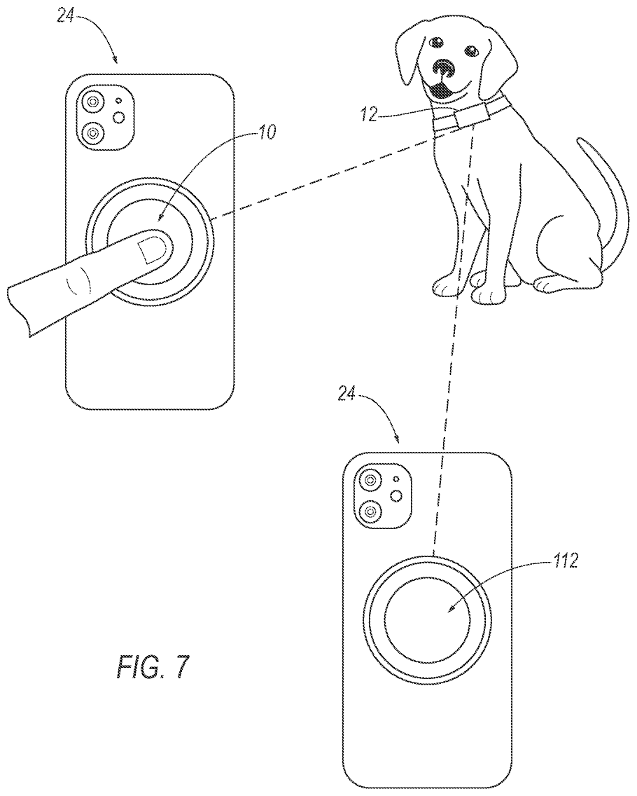

The transmitter 10 may have a base 58 as shown in FIGS. 1B, 2B, and 6. Specifically, the base 58 may be supported by the housing 26. The base 58 may include a printed circuit board (“PCB”). The base 58 itself may be a PCB. In the examples shown in the Figures, the base 58 is a PCB. The base 58 may be any suitable size and/or shape such that it can be supported by the housing 26. In other words, the base 58 may be any suitable size and/or shape that fits within the housing 26. The base 58 may be supported by the housing 26 in any suitable manner, e.g., press-fit, adhesive, fasteners, etc.

The transmitter 10 may have a controller 60. The controller 60 may be integral with the base 58 of the transmitter 10. As another example, the controller 60 may be connected to the base 58 of the transmitter 10. The controller 60 includes a processor and a memory such as are known. The memory includes one or more forms of controller 60 readable media, and stores instructions executable by the controller 60 for performing various operations, including as disclosed herein. The controller 60 may include programming to, e.g., send instructions to the receiver 12.

The controller 60 may include or be communicatively coupled to more than one processor, e.g., included in components, etc. The controller 60 may receive messages from various devices and/or components, e.g., sensors, the human-machine interface, etc. The controller 60 may transmit messages to various devices in the transmitter 10, e.g., a communications module 62 as described below.

The transmitter 10 includes the communications module 62. The communications module 62 may be integral with the base 58 of the transmitter 10. As another example, the communications module 62 may be connected to the base 58 of the transmitter 10. The controller 60 may be configured for communicating to devices outside of the transmitter 10, e.g., the receiver 12, via the communications module 62. Specifically, the receiver 12 may include a controller 60 and the controller 60 of the transmitter 10 may be configured for wirelessly communicating with the controller 60 of the receiver 12 via the communications module 62 of the transmitter 10.

The communications module 62 of the transmitter 10 could include one or more mechanisms by which the controller 60 of the transmitter 10 and the controller 60 of the receiver 12 communicate, including any desired combination of wireless, e.g., cellular, wireless, satellite, microwave and radiofrequency, communications mechanisms and any desired network topology (or topologies when a plurality of communication mechanisms are utilized).

The transmitter 10 may include a radiofrequency transmitter 66. In the example shown in the Figures, the communications module 62 includes the radiofrequency transmitter 66 and an antenna 68. Specifically, in examples where the communications module 62 is integral with the base 58 of the transmitter 10, the base 58 may include the radiofrequency transmitter 66. The controller 60 of the transmitter 10 is configured for wirelessly communicating with the controller 60 of the receiver 12 via the radiofrequency transmitter 66. The radiofrequency transmitter 66 may have any suitable operating frequency. In the example shown in the Figures, the radiofrequency transmitter 66 has an operating frequency of 433 MHz. In other examples, not shown in the Figures, the radiofrequency transmitter 66 may have an operating frequency of 915 MHz or 2.4 GHZ.

The transmitter 10 includes the human-machine interface (“HMI”). The HMI 14 translates a user input into commands for the transmitter 10. Specifically, the HMI 14 translates a user input into instructions for the controller 60 of the transmitter 10. The HMI 14 may be of any suitable type. The HMI 14 may include a button assembly 70. As shown in the figures, the HMI 14 of the transmitter 10 is the button assembly 70. As another example, not shown in the figures, the human machine interface 14 may be a capacitive touch sensor.

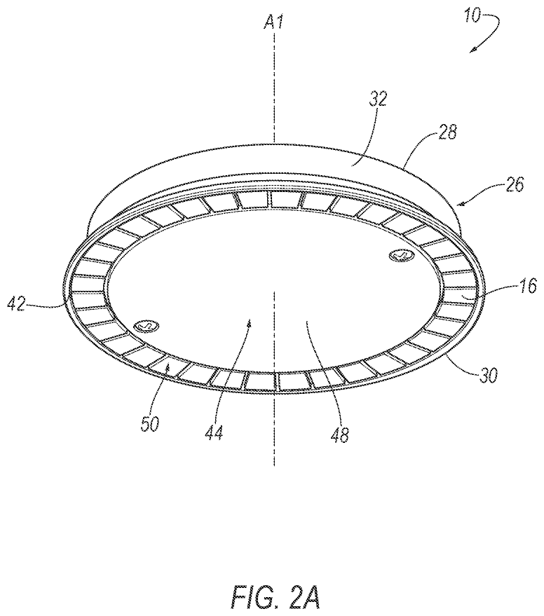

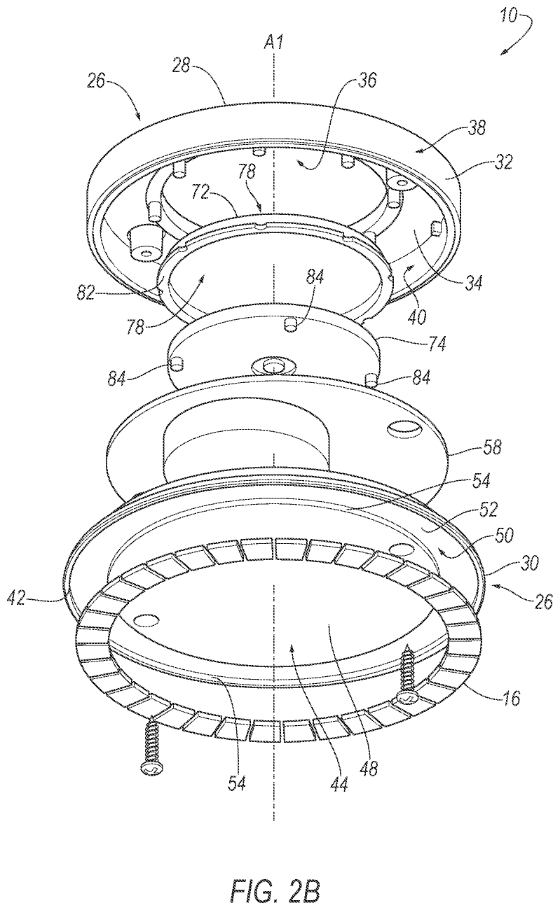

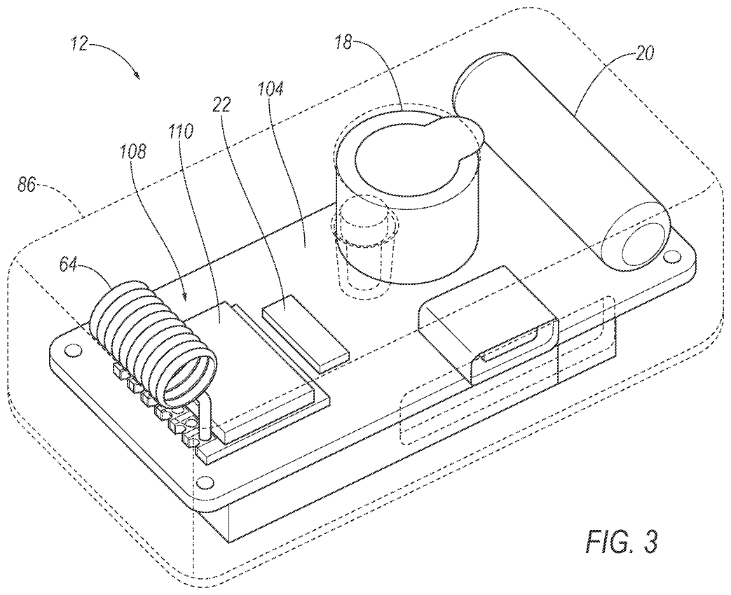

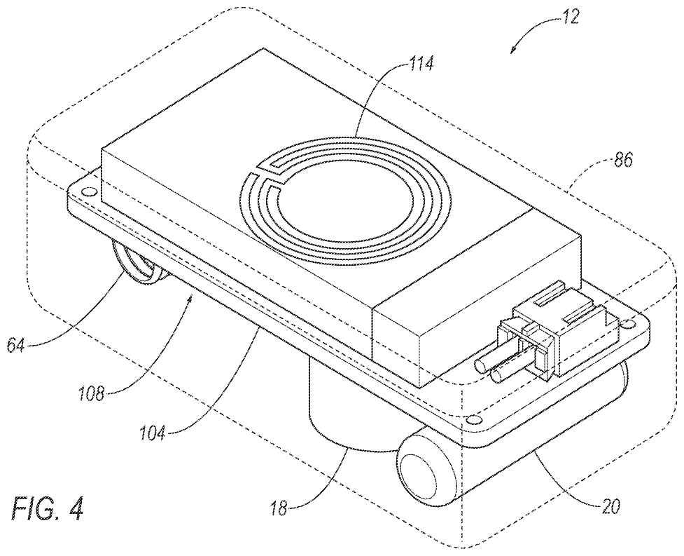

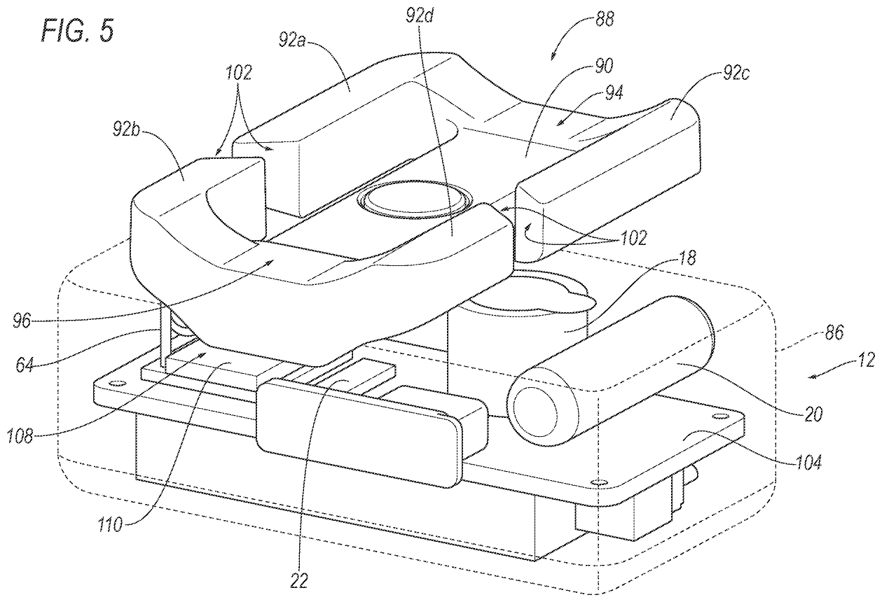

As shown in FIGS. 1A-2B, the transmitter 10 includes the button assembly 70. In the example shown in the Figures, the transmitter 10 includes a single button assembly 70. Specifically, the HMI 14 includes the single button assembly 70. In examples where the HMI 14 includes the single button assembly 70, the HMI 14 includes only one button assembly 70 and no more. In other examples, not shown in the Figures, the transmitter 10, and specifically the HMI 14, may include more than one button assembly 70, e.g., a plurality of button assemblies 70. The button assembly 70 includes a first contact pad 72, a second contact pad 74, and an input sensor 76. The input sensor 76 is connected to the base 58. In the example shown in the Figures, the input sensor 76 is connected to the base 58 on the central axis A1. The input sensor 76 may be any suitable type, e.g., a switch, a trigger, etc.

The first contact pad 72 and the second contact pad 74 are generally circular. The first contact pad 72 is spaced from the base 58 upward relative to the bottom section 30 of the housing 26. Specifically, the first contact pad 72 is spaced from the input sensor 76 along the central axis A1. The first contact pad 72 and the second contact pad 74 each have a neutral position and a pressed position. As used herein, the first contact pad 72 and/or the second contact pad 74 are in the neutral position when no force is applied to the button assembly 70. The first contact pad 72 and/or the second contact pad 74 are moved from the neutral position to the pressed position when a force is applied to the button assembly 70, e.g., by the user's finger.

In the example shown in FIG. 1A, the first contact pad 72 is in the neutral position. In the neutral position, the first contact pad 72 abuts the top section 28 of the housing 26. Specifically, the first contact pad 72 abuts the top flange 34.

The first contact pad 72 may have a top surface 78, a bottom surface 80, and a flange 82. The top surface 78 of the first contact pad 72 is flush with the outer wall 38 of the top section 28. Specifically, the top surface 78 of the first contact pad 72 is flush with the outer wall 38 of the top section 28. The flange 82 of the first contact pad 72 abuts the inner wall 40 of the top section 28. Specifically, the flange 82 of the first contact pad 72 abuts the inner wall 40 of the top flange 34.

The second contact pad 74 is between the first contact pad 72 and the input sensor 76. The second contact pad 74 has a neutral position and a pressed position. In the neutral position, the second contact pad 74 may be spaced from the input sensor 76. Specifically, the second contact pad 74 may have a plurality of standoffs 84 extending toward the base 58. The plurality of standoffs 84 abut the base 58. In the pressed position, the second contact pad 74 abuts the input sensor 76 and applies a force to the input sensor 76. In other examples (not shown), in the neutral position the second contact pad 74 may abut the input sensor 76 without applying a force to the input sensor 76.

In the example shown in the Figures, the first contact pad 72 is rigid and the second contact pad 74 is resilient. The first contact pad 72 is rigid relative to the second contact pad 74 and the second contact pad 74 is resilient relative to the first contact pad 72. In other words, the second contact pad 74 is resiliently flexible. Specifically, because the first contact pad 72 is rigid, the first contact pad 72 does not deform when moved from the neutral position to the pressed position. Because the second contact pad 74 is resilient, the second contact pad 74 will elastically deform when moved from the neutral position to the pressed position and will return to its original shape when the second contact pad 74 is moved from the pressed position to the neutral position.

The first contact pad 72 may be formed of a rigid material, e.g., plastic, that resists deformation when a force is applied, e.g., force from the user's thumb or finger. The second contact pad 74 may be formed of a resilient material, e.g., silicone, flexible polymer, etc. In other examples, not shown in the Figures, the first contact pad 72 may be resilient relative to the second contact pad 74 and the second contact pad 74 may be rigid relative to the first contact pad 72. In other words, the first contact pad 72 or the second contact pad 74 may be rigid and the other of the first contact pad 72 or the second contact pad 74 may be resilient.

As discussed above, the HMI 14 translates the user input into instructions for the controller 60 of the transmitter 10. In the example where the HMI 14 is the button assembly 70, when the user applies a force to the button assembly 70 to move the first contact pad 72 and the second contact pad 74 from the neutral position to the pressed position, the input sensor 76 detects the user input. When the input sensor 76 detects the user input, the input sensor 76 sends a signal to the controller 60. The controller 60 may be programmed to instruct the communications module 62 to transmit instructions to the receiver 12 as described below.

The receiver 12 may include a housing 86. As shown in the Figures, the housing 86 may be generally rectangularly cuboidal, i.e., the housing 86 has a height, a width, and a depth. The housing 86 is designed to be supported on a pet collar. The housing 86 may be of any suitable size and/or shape that is supportable on the pet collar.

The receiver 12 may include a clip 88. As shown in the Figures, the clip 88 is supported by the housing 86. The clip 88 includes a body 90 and a plurality of arms 92 extending from the body 90. The body 90 of the clip 88 has a first end 94 and a second end 96 spaced from the first end 94. The body 90 is elongated from the first end 94 to the second end 96. The body 90 has a first side 98 and a second side 100 spaced from the first side 98. The first side 98 and the second side 100 each extend from the first end 94 to the second end 96.

The plurality of arms 92 are connected to the body 90. As shown in the Figures, the plurality of arms 92 includes a first arm 92a, a second arm 92b, a third arm 92c, and a fourth arm 92d. The first arm 92a, the second arm 92b, the third arm 92c, and the fourth arm 92d are L-Shaped.

The first arm 92a and the third arm 92c are connected to the first end 94 of the body 90. Specifically, the first arm 92a extends from the first side 98 at the first end 94 and the third arm 92c extends from the first side 98 at the second end 96. The first arm 92a and the third arm 92c extend toward the second end 96. The first arm 92a and the third arm 92c each have a terminal end 102.

The second arm 92b and the third arm 92c are connected to the second end 96 of the body 90. The second arm 92b extends from the second side 100 at the first end 94. The fourth arm 92d extends from the second side 100 at the second end 96. The second arm 92b and the fourth arm 92d extend toward the first end 94. The second arm 92b and the fourth arm 92d each have a terminal end 102. The terminal end 102 of the first arm 92a is spaced from and opposite the terminal end 102 of the second arm 92b. The terminal end 102 of the third arm 92c is spaced from and opposite the terminal end 102 of the fourth arm 92d. As shown in the Figures, the clip 88 may, for example, secure the receiver 12 to the collar of the user's pet.

The receiver 12 has a base 104. The base 104 of the receiver 12 may be supported by the housing 86. The base 104 may include a printed circuit board (“PCB”). The base 104 itself may be a PCB. In the example shown in the Figures, the base 104 is a PCB. The base 104 may be any suitable size and/or shape such that it can be supported by the housing 86. In other words, the base 104 may be any suitable size and/or shape that fits within the housing 86. The base 104 may be supported by the housing 86 in any suitable manner.

The receiver 12 may have a controller 106. The controller 106 may be connected to the base 104 of the receiver 12. As another example, the controller 106 may be integral with the base 104 of the receiver 12. The controller 106 includes a processor and a memory such as are known. The memory includes one or more forms of controller 106 readable media, and stores instructions executable by the controller 106 for performing various operations, including as disclosed herein. The controller 106 may include programming to instruct the vibration motor 20 to operate and/or instruct the noise-generator to generate noise.

The controller 106 may include or be communicatively coupled to more than one processor, e.g., included in components, etc. The controller 106 may receive messages from various devices and/or components, e.g., sensors, the noise generator 18, the vibration motor 20, etc. The controller 106 may transmit messages to various devices in the receiver 12, e.g., sensors, the noise generator 18, the vibration motor 20, etc.

The receiver 12 includes a communications module 108. The communications module 108 may be connected to the base 104 of the receiver 12. As another example, the communications module 108 may be integral with the base 104 of the receiver 12. The controller 106 may be configured for communicating with devices outside of the receiver 12, e.g., the transmitter 10, via the communications module 108. As described above, the transmitter 10 and the receiver 12 may each include a controller 60, 106 and a communications module 62, 108 and the controllers 60, 106 may be configured for wirelessly communicating with each other via the communications modules 62, 108 of the transmitter 10 and the receiver 12.

The communications module 108 of the receiver 12 could include one or more mechanisms by which the controller 106 of the receiver 12 and the controller 60 of the transmitter 10 communicate, including any desired combination of wireless, e.g., cellular, wireless, satellite, microwave and radiofrequency, communications mechanisms and any desired network topology (or topologies when a plurality of communications mechanisms are utilized).

The receiver 12 includes a radiofrequency receiver 110. In the example shown in the Figures, the communications module 108 includes the radiofrequency receiver 110 and an antenna 64. The controller 106 of the receiver 12 is configured for wirelessly communicating with the controller 60 of the transmitter 10 via the radiofrequency receiver 110. The radiofrequency receiver 110 may have any suitable operating frequency. In the example shown in the Figures, the radiofrequency receiver 110 has an operating frequency of 433 MHz. In other examples, not shown in the Figures, the radiofrequency receiver 110 may have an operating frequency of 915 MHz or 2.4 GHZ.

The receiver 12 includes the proximity sensor 22. As shown in the Figures, the proximity sensor 22 is supported by the base 104. In other examples, the proximity sensor 22 may be integral with the base 104. The proximity sensor 22 is a contactless sensor. The proximity sensor 22 may include a sensing element, a signal processor, and an output. The proximity sensor 22 may detect the presence of the transmitter 10 without any physical contact. Specifically, the proximity sensor 22 has a detection field and the proximity sensor 22 may detect the presence of the transmitter 10 without any physical contact when the transmitter 10 is in the detection field.

The proximity sensor 22 may be an inductive sensor. The inductive sensor may emit an electromagnetic field and may sense changes in the electromagnetic field. In this instance, for example, the inductive sensor senses changes in the electromagnetic field induced by the plurality of magnets 16 of the transmitter 10. As an example, the inductive sensor may be a Hall-Effect sensor.

The proximity sensor 22 may be communicatively connected to other components, e.g., the controller 106, etc. In examples where the proximity sensor 22 is communicatively coupled with the controller 106, the proximity sensor 22 may transmit a signal to the controller 106 and the controller 106 sends instructions to component(s) that are communicatively connected to the controller 106.

The receiver 12 has a first state and a second state. As an example, the radiofrequency receiver 110 may have a first state and a second state. In the first state the radiofrequency receiver 110 is paired with the radiofrequency transmitter 66, or a plurality of radiofrequency transmitters 66. In the first state the radiofrequency receiver 110 may be paired with no radiofrequency transmitters 66. The radiofrequency transmitter 66 is pairable with the radiofrequency receiver 110 when the receiver 12, i.e., the radiofrequency receiver 110, is in the second state. In the second state, the radiofrequency receiver 110 is pairable with the radiofrequency transmitter 66, or a plurality of radiofrequency transmitters 66. As discussed above, the proximity sensor 22 may be an inductive sensor. The receiver 12 is configured to change from the first state to the second state in response to detection of a magnetic field by the proximity sensor 22. When the proximity sensor 22 detects a change in its magnetic field, i.e., within the detection field, from, for example, the plurality of magnets 16, the proximity sensor 22 may send a signal to the controller 106. In response to receiving the signal from the proximity sensor 22, the controller 106 instructs the receiver 12, i.e., the radiofrequency receiver 110, to change from the first state to the second state. In the second state, the radiofrequency transmitter 66 can be paired with the radiofrequency receiver 110. As an example, when the radiofrequency transmitter 66 is paired with the radiofrequency receiver 110, as described below, the radiofrequency receiver 110 changes from the second state to the first state. In other examples, the radiofrequency receiver 110 may change from the second state to the first state after a specified period of time has elapsed.

The transmitter 10, i.e., the radiofrequency transmitter 66, and the receiver 12, i.e., the radiofrequency receiver 110, are paired when the radiofrequency receiver 110 and the radiofrequency transmitter 66 have a common address. When the radiofrequency receiver 110 is in the second state, the radiofrequency receiver 110 can be programmed to have the same address, i.e., the common address, as the radiofrequency transmitter 66. When the radiofrequency transmitter 66 transmits a signal, the signal includes the common address.

When the radiofrequency receiver 110 is programmed with the same address, i.e., the common address, the radiofrequency receiver 110 receives the signal from the transmitter. As an example, the radiofrequency transmitter 66 may have an address of “0001” and the radiofrequency receiver 110 is programmed to receive signals that include the address “0001.” In this example, a second transmitter 112, i.e., a second radiofrequency transmitter 66, has an address of “0010”, the radiofrequency receiver 110 would not receive that signal because the address is not “0001.”

The radiofrequency receiver 110 may be programmed with a plurality of addresses. Specifically, the memory of the radiofrequency receiver 110 may store the plurality of addresses. As an example, the radiofrequency receiver 110 may store the addresses of a plurality of radiofrequency transmitters 66, e.g., the radiofrequency transmitter 66 and the second radiofrequency transmitter 66. In the example above, the radiofrequency receiver 110 may store the address “0001” and “0010”. In other words, the second transmitter 112, i.e., the second radiofrequency transmitter 66, is pairable with the receiver 12 when the receiver 12 is in the second state. In this example, the radiofrequency receiver 110 may receive the signal from the radiofrequency transmitter 66 with the address “0001” and the second radiofrequency transmitter 66 with the address “0010”. When the radiofrequency receiver 110 stores the address of the radiofrequency transmitter 66 the, the transmitter 10 and the receiver 12 are paired.

As an example, shown in the Figures, the receiver 12 is attached to the collar of a dog, via the clip 88, and the receiver 12 is programmed with the addresses of the transmitter 10 and the second transmitter 112. Each of the transmitter 10 and the second transmitter 112 may transmit a signal to the receiver 12. In this example, the noise generator 18 and/or the vibration motor 20 are each operable by the transmitter 10 and/or the second transmitter 112.

In an example, not shown in the Figures, the transmitter 10 may include a plurality of button assemblies 70. Specifically, the transmitter 10 may include a first button assembly and a second button assembly. In this example, the transmitter 10 may include a first radiofrequency transmitter and a second radiofrequency transmitter. The first button assembly is communicatively coupled with the first radiofrequency transmitter and the second button assembly is communicatively coupled with the second radiofrequency transmitter. The first radiofrequency transmitter may be paired with a first radiofrequency receiver and the second radiofrequency transmitter may be paired with a second radiofrequency receiver. In this example, the transmitter 10 can control two separate receivers with each button assembly.

The receiver 12 includes the noise generator 18. In the example shown in the Figures, the noise generator 18 is supported on the base 104 of the receiver 12. In other examples, the noise generator 18 may be integral with the base 104. The noise generator 18 may be a piezo-electric buzzer. The noise generator 18 may be of any suitable type, e.g., the piezo-electric buzzer, a speaker, etc. The noise generator 18 is operable by the HMI 14 when the transmitter 10 and the receiver 12 are paired. Specifically, the noise generator 18 is communicatively connected with the controller 106 of the receiver 12. As described below, the noise generator 18 may receive instructions from the controller 106 of the receiver 12 to, e.g., activate or make noise.

The receiver 12 includes the vibration motor 20. In examples shown in the Figures, the vibration motor 20 is supported on the base 104 of the receiver 12. In other examples, the vibration motor 20 may be integral with the base 104. The vibration motor 20 may be, e.g., an eccentric rotating mass, a linear resonant actuator, a solenoid actuator, etc. As shown in the Figures, the vibration motor 20 is an eccentric rotating mass. The vibration motor 20 may be any suitable type. The vibration motor 20 is operable by the HMI 14 when the transmitter 10 and the receiver 12 are paired. Specifically, the vibration motor 20 is communicatively connected with the controller 106 of the receiver 12. As described below, the vibration motor 20 may receive instructions from the controller 106 of the receiver 12 to, e.g., activate or vibrate.

The receiver 12 may include a near-field communication tag 114 (“NFC tag”). The NFC tag 114 may be integral with the base 104 of the receiver 12. As another example, the NFC tag 114 may be connected to the base 104 of the receiver 12. The NFC tag 114 may include a memory and an induction coil. The memory of the NFC tag 114 may include, for example, a website address that when read by an NFC reader directs the NFC reader to open the website. In some examples, the NFC tag 114 may operate and/or be of suitable construction as is known the art.

The receiver 12 may include a GPS module (not shown). The GPS module may be integral with the base 104 of the receiver 12. As another example, the GPS module may be connected to the base 104 of the receiver 12. The GPS module may communicate with a third-party device, e.g., a satellite. Specifically, the GPS module may communicate location data of the receiver 12 to the third-party device. In some examples, the GPS module may be any suitable GPS module known in the art.

The receiver 12 and/or the transmitter 10 may include a hydrophobic coating (not shown). Specifically, the base 104 of the receiver 12 and the components supported by the base 104 of the receiver 12 and/or the base 58 of the transmitter 10 and the components supported by the base 58 of the transmitter 10 may include the hydrophobic coating. The hydrophobic coating repels water. As an example, when the receiver 12 and/or the transmitter 10 includes the hydrophobic coating, the receiver 12 and/or the transmitter 10 will be operational under water. The hydrophobic coating may be applied by, for example, dipping the base 104 of the receiver 12 and the components supported by the base 104 of the receiver 12 and/or the base 58 of the transmitter 10 and the components supported by the base 58 of the transmitter 10 in the hydrophobic coating. The hydrophobic coating may be applied to all exterior surfaces of the base 104 of the receiver 12 and the components supported by the base 104 of the receiver 12 and/or the base 58 of the transmitter 10 and the components supported by the base 58 of the transmitter 10.

As described above, the transmitter 10 and the receiver 12 may be paired, i.e., in communication with each other. When the transmitter 10 and the receiver 12 are paired, the transmitter 10 may send instructions to the receiver 12 to operate the components of the receiver 12, e.g., the noise generator 18, the vibration motor 20, etc. Specifically, the user may initiate the transmission of instructions via the HMI 14. In examples where the HMI 14 is the button assembly 70, the user can initiate transmission of instructions from the transmitter 10 to the receiver 12 via applying a force, i.e., pressing, to the button assembly 70. As described above, the button assembly 70 may include the input sensor 76 to detect the force applied by the user. The input sensor 76 may, for example, detect that the user applied the force to the button assembly 70. In response to the information from the sensor, the controller 60 instructs the receiver 12 to operate the components of the receiver 12, e.g., via the communications modules 62, 108.

As shown in the Figures, the button assembly 70 may be a single button assembly 70. In this example, the controller 60 is programmed to, in response to the user pressing the button assembly 70, send instructions from the transmitter 10 to the receiver 12. As described further below, the controller 60 may be programmed to send instructions from the transmitter 10 to the receiver 12 in response to how the user applies the force to the button assembly 70, e.g., a single press, a long press and a short press, a double press, a triple press, etc. In this example, because the transmitter 10 has the single button assembly 70, the user does not need to identify, e.g., visually, tactilely, etc., separate button assemblies 70 for separate functions.

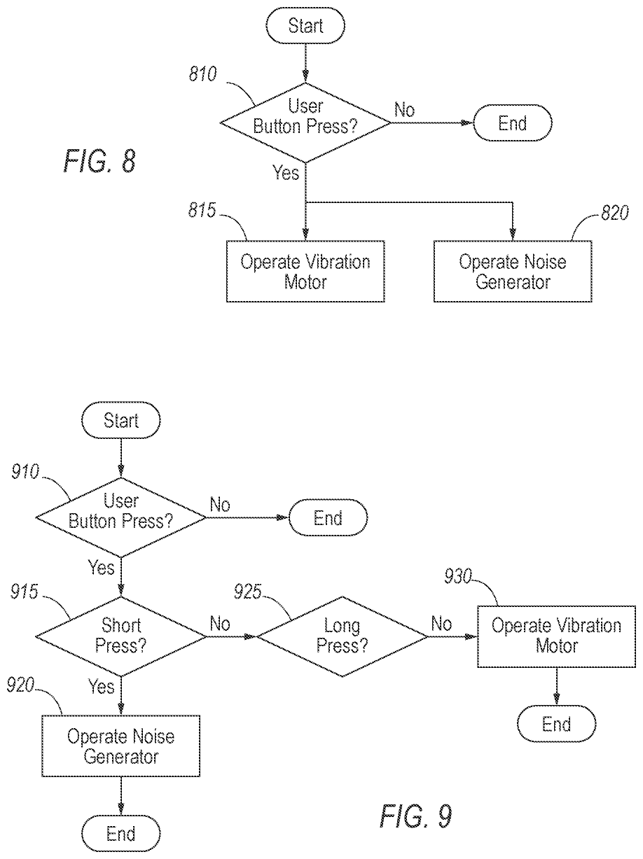

As an example shown in the method in FIG. 8, the controller 60 may be programmed to, in response to a single press, instruct the receiver 12 to operate both the noise generator 18 and the vibration motor 20. With reference to block 810, the method includes identifying whether the button assembly 70 has been pressed. If a press of the button assembly 70 is not identified, the method ends. If a press of the button assembly 70 is identified, the method moves to block 815 and block 820. With reference to block 815, the receiver 12 operates the vibration motor 20. With reference to block 820, the receiver 12 operates the noise generator 18 and the method ends. As shown in the Figure, blocks 815 and 820 are performed simultaneously. As an example not shown in the Figures, the noise generator 18 may be operated before vibration motor 20. As another example not shown in the Figures, the receiver 12 may operate the vibration motor 20 before the noise generator 18.

As an example shown in the method in FIG. 9, the controller 60 may identify the short press and the long press. With reference to block 910, the method includes identifying whether the button assembly 70 has been pressed. If a press of the button assembly 70 is not identified, the method ends. If a press of the button assembly 70 is identified, the method moves to block 915. With reference to block 915, the method includes identifying whether the user has used the short press. If the user used the short press, the method moves to block 920. If the user did not use the short press, the method moves to block 925. If the user used the long press, the method moves to block 930.

With reference to block 920, in response to the short press, the receiver 12 operates the noise generator 18. With reference to block 930, in response to the long press, the receiver 12 operates the vibration motor 20. As an example not shown in the Figures, the receiver 12 may operate the noise generator 18 in response to the long press and the receiver 12 may operate the vibration motor 20 in response to the short press.

As another example, the user may use a single tap, a double tap, and a triple tap to operate the noise generator 18 and/or the vibration motor 20. The controller 60 may be programmed to receive information from the input sensor 76 and determine that the user has used the single tap, the double tap, or the triple tap. Specifically, the controller 60 may be programmed to determine whether the user has used the single tap, the double tap, or the triple tap, based on the time elapsed between taps. For example, the controller 60 may be programmed such that when at least 0.5 seconds elapses between taps, each tap is interpreted as a single tap, and when less than 0.5 seconds elapses between taps, the taps are interpreted as the double tap or the triple tap.

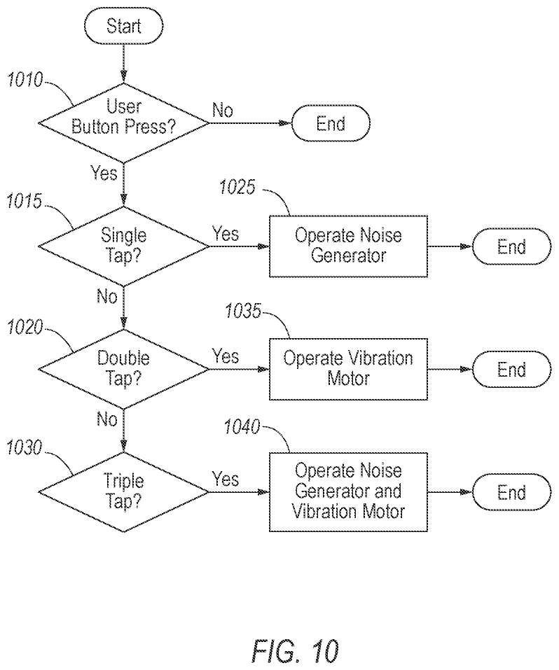

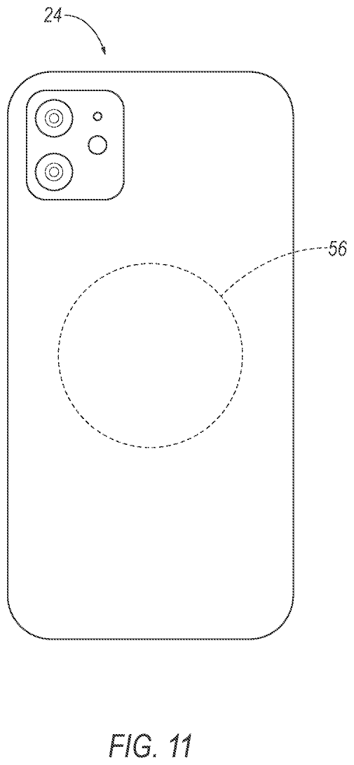

As an example shown in the method in FIG. 10, the controller 60 may identify a single tap, a double tap, and a triple tap of the button assembly 70. With reference to block 1010, the method includes identifying whether the button assembly 70 has been pressed. If a press of the button assembly 70 is not identified, the method ends. If a press of the button assembly 70 is identified, the method moves to block 1015. With reference to block 1015, the method includes identifying whether the user has used the single tap. If the user has not used the single tap, the method moves to block 1020. If the user has used the single tap, the method moves to block 1025.

With reference to block 1025, in response to the single tap, the receiver 12 operates the noise generator 18. With reference to block 1020, the method includes identifying whether the user has used the double tap. If the user has not used the double tap, the method moves to block 1030. If the user has used the double tap, the method moves to block 1035.

With reference to block 1035, in response to the double tap, the receiver 12 operates the vibration motor 20. With reference to block 1030, the method includes identifying whether the user has used the triple tap. If the user has not used the triple tap, the method ends. If the user has used the triple tap, the method moves to block 1040. With reference to block 1040, in response to the triple tap, the receiver 12 operates the noise generator 18 and the vibration motor 20, e.g., simultaneously or sequentially.

In other examples, not shown in the Figures, the transmitter 10 may have a plurality of button assemblies 70. In examples where the transmitter 10 includes the plurality of button assemblies 70, the controller 60 may be programmed to instruct the receiver 12 to operate a single function of the receiver 12, e.g., the noise generator 18 or the vibration motor 20, in response to the use pressing one of the plurality of the button assemblies 70.

This disclosure has been described in an illustrative manner, and it is to be understood that the terminology which has been used is intended to be in the nature of words of description rather than of limitation. Use of “in response to,” “based on,” and “upon determining” herein indicates a causal relationship, not merely a temporal relationship. Many modifications and variations of the present disclosure are possible in light of the above teachings, and the disclosure may be practiced otherwise than as specifically described.

1. A system comprising:
a transmitter having a human machine interface and a plurality of magnets;
a receiver having a noise generator and a vibration motor;
the receiver having a first state and a second state;
the receiver having a proximity sensor, the receiver being configured to change from the first state to the second state in response to detection of a magnetic field by the proximity sensor;
the transmitter being pairable with the receiver when the receiver is in the second state;
the noise generator and the vibration motor each being operable by the human machine interface when the transmitter and the receiver are paired; and
the transmitter being magnetically couplable to a user device by the plurality of magnets.

2. The system of claim 1, wherein the transmitter includes a radiofrequency transmitter, the receiver includes a radiofrequency receiver, the radiofrequency transmitter being pairable with the radiofrequency receiver when the receiver is in the second state.

3. The system of claim 2, wherein the radiofrequency transmitter and the radiofrequency receiver each operate at 433 MHz.

4. The system of claim 1, wherein the human machine interface includes a button assembly, the button assembly including an input sensor, a first contact pad spaced from the input sensor, and a second contact pad between the first contact pad and the input sensor.

5. The system of claim 4, wherein the human machine interface includes a single button assembly.

6. The system of claim 5, wherein the noise generator and the vibration motor are each operable by the single button assembly.

7. The system of claim 4, wherein the first contact pad or the second contact pad is rigid relative to the other of the first contact pad or the second contact pad and the other of the first contact pad or the second contact pad is resilient relative to the first contact pad or the second contact pad.

8. The system of claim 4, wherein the first contact pad is rigid relative to the second contact pad and the second contact pad is resilient relative to the first contact pad.

9. The system of claim 1, including a second transmitter being pairable with the receiver in the second state, the noise generator and the vibration motor each being operable by the transmitter and/or the second transmitter.

10. The system of claim 1, wherein the transmitter includes a top section and a central axis, the top section having an opening extending radially from the central axis.

11. The system of claim 10, wherein the top section includes a top flange and a side extending downwardly from the top flange and extending continuously around the central axis, the top flange extending inwardly from the side toward the central axis, the top flange defining the opening.

12. The system of claim 11, wherein the human machine interface is disposed within the opening.

13. The system of claim 10, wherein the transmitter includes a bottom section, the bottom section having an outer edge and a channel extending continuously around the bottom section adjacent the outer edge, the plurality of magnets being arranged in the channel.

14. The system of claim 1, wherein the receiver includes a housing and a clip supported by the housing, the clip having a body and a plurality of arms extending from the body, the plurality of arms being L-shaped.

15. The system of claim 14, wherein the body has a first end and a second end, the plurality of arms include a first arm, a second arm, a third arm, and a fourth arm, the first arm and the third arm being connected to the first end of the body and extending away from the body and extending toward the second end, the second arm and the fourth arm being connected to the second end of the body and extending away from the body and extending toward the first end.

16. An assembly comprising:
a housing having a top section, a bottom section, and a central axis;
the top section having an opening extending radially from the central axis;
a human machine interface, the human machine interface being disposed within the opening;
a base supported on the bottom section, the base including a radio frequency transmitter;
the bottom section having a channel extending continuously around the central axis; and
a plurality of magnets supported by the bottom section, the plurality of magnets being arranged within the channel.

17. The assembly of claim 16, wherein the housing is magnetically couplable to a user device by the plurality of magnets.

18. The assembly of claim 16, wherein the human machine interface includes a button assembly, the button assembly including an input sensor, a first contact pad spaced from the input sensor on the central axis, and a second contact pad between the first contact pad and the input sensor.

19. The assembly of claim 18, wherein the first contact pad or the second contact pad is rigid and the other of the first contact pad or the second contact pad is resilient.
